(19) United States
(12) Patent Application Publication
(10) Pub. No.: US 2010/0272385 A1
(43) Pub. Date: Oct. 28, 2010

(54) OPTICAL WAVEGUIDE DEVICE AND METHOD OF MANUFACTURING OPTICAL WAVEGUIDE DEVICE

(76) Inventor: Noriyuki Akiyama, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/159,171

(22) PCT Filed: Dec. 14, 2006
(86) PCT No.: PCT/JP2006/324935

§ 371 Date: Jun. 25, 2008

(30) Foreign Application Priority Data
Dec. 28, 2005 (JP) 2005-378392

(51) Int. Cl. G02B 6/12; G02B 6/132

(52) U.S. Cl. 385/14; 264/1.28

(57) ABSTRACT

Residue is prevented from being generated in a groove on a substrate. An optical waveguide device is provided with the substrate (10) having a V-groove (11) for attaching optical fibers (41-45); a lower clad layer formed on the substrate (10); a core layer having an optical waveguide pattern formed on the lower clad layer; and an upper clad layer formed on the lower clad layer and the core layer having the optical waveguide pattern. The sum of the thickness of the lower clad layer and the thickness of the core layer is 18 [μm] or more.

### TECHNICAL FIELD

The present invention relates to an optical waveguide device and a method of manufacturing an optical waveguide device.

### BACKGROUND ART

Conventionally, a technique for forming an optical waveguide on a substrate such as a planar lightwave circuit (PLC) has been carried out. For example, a splitter, an optical switch or the like are formed using the PLC. In another example, an optical waveguide chip that can connect a PLC as a splitter to an optical fiber for inputting or outputting light to or from an optical waveguide of the PLC has been carried out.

There are two types of possible optical waveguide chips. A first type is an optical waveguide chip configured to include a PLC substrate and a connection substrate which are provided separately. The connection substrate connects an optical fiber for inputting or outputting light to or from an optical waveguide of the PLC substrate. A second type is an optical waveguide chip of an integrated type configured to include a PLC section and a connection section, both of which are formed on the same substrate (see, for example, Patent Documents 1 and 2). The connection section of the optical waveguide chip of the integrated type includes a V-groove for fixing a position of the optical fiber.

A method of manufacturing the optical waveguide chip of the integrated type will be described. First, one substrate is cut out from Si or the like and a V-groove is formed at a position of the connection section of the substrate. It is assumed that a plurality of optical waveguide chips are formed on the one substrate. A lower cladding layer and a core layer as an optical waveguide are formed on the substrate in sequence, and a photoresist layer for photolithography is also formed by spin coating. Since the lower cladding layer, the core layer, and the photoresist layer are formed on an entire surface of the substrate, these layers are formed not only on the PLC section but also on the V-groove.

FIG. 13 shows a longitudinal section of a connection section 50 in which a photoresist layer 54 is formed. As shown in FIG. 13, a substrate 10 in which a V-groove 11 is formed, a lower cladding layer 51 formed on the substrate 10, a core layer 52 formed on the lower cladding layer 51, and the photoresist layer 54 formed on the core layer 52, for example, are formed in the connection section 50 of an optical waveguide chip.

Next, the photoresist layer of a PLC section is exposed from above a mask of an optical waveguide pattern and the core layer (and the photoresist layer) that do not have the optical waveguide pattern on an entire surface are removed by dry etching. The photoresist layer having the optical waveguide pattern is removed by wet etching and an upper cladding layer is formed on the core layer and the lower cladding layer. The optical waveguide chips are separated from one another. At that time, the lower cladding layer, the core layer, and the upper cladding layer of the connection section (on the V-groove) are removed. An optical fiber for inputting and outputting light is adhesively attached to the V-groove on each of the optical waveguide chips and a cover for fixing the optical fiber is attached, whereby each of the optical waveguide chips is used as an optical waveguide module.

### Patent Document 1: Japanese Patent Application Laid-Open No. 2003-302545;

### Patent Document 2: Japanese Patent Application Laid-Open No. 1-126608.

### DISCLOSURE OF INVENTION

### Problem to be Solved by the Invention

However, in the conventional optical waveguide chip of the integrated type, the lower cladding layer, the core layer, and the upper cladding layer of the connection section (on the V-groove) of the substrate cannot be removed with high accuracy. Specifically, as shown in FIG. 13, since depth of the V-groove 11 is large, e.g., about 100 [μm], some parts on which a resist material is not applied appears at edges 55 of the V-groove 11 when forming the photoresist layer 54. Since the resist material is not applied on these parts, the parts are chipped off during the removal of the core layer 52 (and the photoresist layer 54) that do not have the optical waveguide pattern, thereby resulting in occurrence of a crack.

The crack reaches the V-groove 11, so that a solution of wet etching enters between the V-groove 11 and the lower cladding layer 51 at the time of removing the photoresist layer 54 having the optical waveguide pattern. Since it is difficult to completely remove the solution entering between the V-groove 11 and the lower cladding layer 51, the upper cladding layer and the lower cladding layer 51 adhere onto the V-groove 11 as a residue when removing these layers. This residue disadvantageously causes displacement of the optical fiber at the time of attaching the optical fiber to the V-groove 11, thereby resulting in occurrence of great connection loss.

It is an object of the present invention to prevent occurrence of a residue in a groove on a substrate.

### Means for Solving the Problem

To achieve the above object, an optical waveguide device set forth in claim 1 is characterized by including: a substrate having a groove for fixing an optical fiber; a lower cladding layer formed on the substrate; a core layer having an optical waveguide pattern formed on the lower cladding layer; and an upper cladding layer formed on the lower cladding layer and the core layer having the optical waveguide pattern, wherein a sum of thickness of the lower cladding layer and thickness of the core layer is 18 [μm] or more.

The invention set forth in claim 2 is characterized in that the sum of the thickness of the lower cladding layer and the thickness of the core layer is 35 [μm] or lower in the optical waveguide device of claim 1.

A method of manufacturing an optical waveguide device set forth in claim 3 is characterized by including: a step of forming a groove for fixing an optical fiber, on a substrate; a lower cladding layer step of forming a lower cladding layer on the substrate; a core layer step of forming a core layer on the lower cladding layer; a step of forming a photoresist layer on the core layer; a step of removing the core layer and the photoresist layer that do not have an optical waveguide pattern, and of removing a remaining photoresist layer; a step of forming an upper cladding layer on the lower cladding layer and the core layer having the optical waveguide pattern; and a step of removing the lower cladding layer, the core layer, and the upper cladding layer on the groove to manufacture the optical waveguide device, wherein in the lower cladding layer step and the core layer step, a sum of thickness of the lower cladding layer and thickness of the core layer is set to be 18 [μm] or more.

The invention set forth in claim 4 is characterized in that in the lower cladding layer step and the core layer step, the sum of the thickness of the lower cladding layer and the thickness of the core layer is set to be 35 [μm] or lower in the method of manufacturing an optical waveguide device of claim 3.

The invention set forth in claim 5 is characterized in that in the lower cladding layer step and the core layer step, the lower cladding layer and the core layer are formed by spin coating or spray coating in the method of manufacturing an optical waveguide device of claim 3 or 4.

### EFFECT OF THE INVENTION

According to the invention set forth in claims 1 and 3, because the sum of the thickness of the lower cladding layer and the thickness of the core layer is set to be equal to or larger than 18 [μm], it is possible to prevent occurrence of a residue in the groove on the substrate at the time of manufacturing the optical waveguide device, to prevent displacement of the optical fiber to be fixed to the groove, and to reduce connection loss.

According to the invention set forth in claims 2 and 4, because the lower cladding layer and the core layer are formed so that the sum of the thickness of the lower cladding layer and the thickness of the core layer is set to be equal to or smaller than 35 [μm], it is possible to reduce nonuniformity in thickness distribution of the lower cladding layer and the core layer.

According to the invention set forth in claim 5, because the lower cladding layer and the core layer are formed by spin coating or spray coating, it is possible to easily adjust the thicknesses of the lower cladding layer and the core layer.

### BRIEF DESCRIPTION OF DRAWINGS

FIG. 1 is a schematic diagram showing a configuration of an optical waveguide module 1 according to embodiments of the present invention.

FIG. 2 is a perspective view showing a configuration of a part of a PLC section 20.

FIG. 3 is a perspective view showing a configuration of a part of a connection section 30A.

FIG. 4A is a plan view of a wafer 200 in a V-groove forming step.

FIG. 4B is a plan view of a wafer 201 in a lower cladding layer forming step.

FIG. 5A is a plan view of a wafer 202 in a core layer forming step.

FIG. 5B is a plan view of a wafer 203 in a photoresist layer forming step.

FIG. 6A is a plan view of a wafer 204 in a photolithographic step.

FIG. 6B is a plan view of a wafer 205 in a core layer removing step.

FIG. 7A is a plan view of a wafer 206 in a photoresist layer removing step.

FIG. 7B is a plan view of a wafer 207 in an upper cladding layer step.

FIG. 8 is a plan view of an optical waveguide chip 100 in a chipping step.

FIG. 9A is a longitudinal sectional view of the wafer in the V-groove forming step.

FIG. 9B is a longitudinal sectional view of the wafer in the lower cladding layer forming step.

FIG. 9C is a longitudinal sectional view of the wafer in the core layer forming step.

FIG. 10A is a longitudinal sectional of the wafer in the photoresist layer forming step.

FIG. 10B is a longitudinal sectional view of the wafer in the photoresist layer removing step.

FIG. 10C is a longitudinal sectional view of the wafer in the chipping step.

FIG. 11 is a graph showing a relationship between spinning speed and film thickness during spin coating.

FIG. 12 is a graph showing a relationship between thickness (d1+d2) and a crack occurrence rate after etching (RIE) for removing the core layer.

FIG. 13 is a longitudinal sectional view of a connection section 50 in which a photoresist layer 54 is formed.

### BEST MODE FOR CARRYING OUT THE INVENTION

Embodiments of the present invention will be explained in detail below with reference to the drawings. The scope of the invention is not to be limited to what is shown in the drawings.

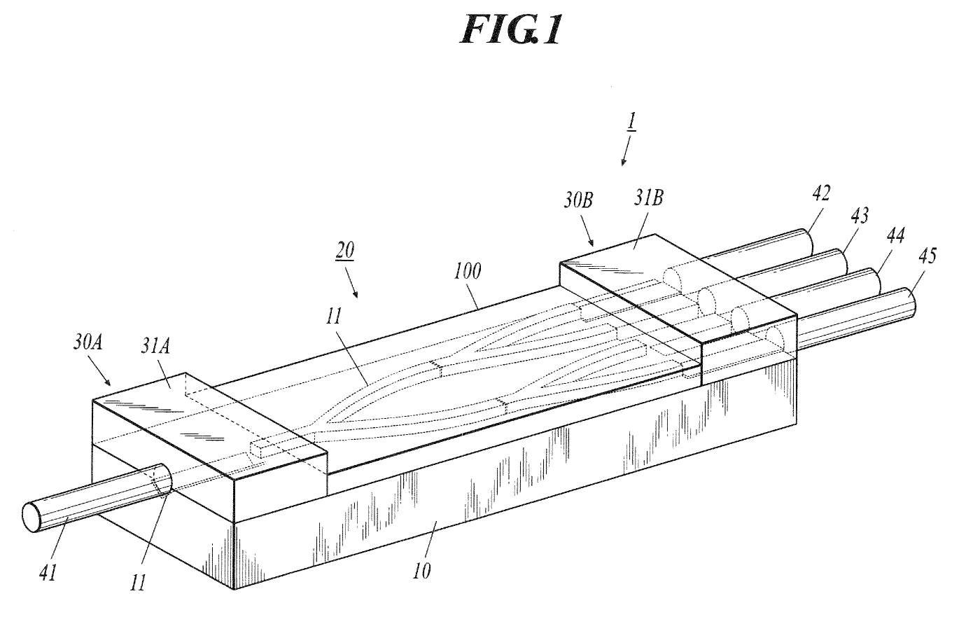

Referring to FIGS. 1 to 12, embodiments of the present invention will be described. Referring to FIGS. 1 to 3, a device configuration of an optical waveguide chip 100 according to the embodiments will first be described. FIG. 1 shows a configuration of an optical waveguide module 1 according to the embodiments.

As shown in FIG. 1, the optical waveguide module 1 of an integrated type is configured to include an optical waveguide chip 100 as an optical waveguide device and optical fibers 41 to 45. The optical waveguide chip 100 is configured to include a PLC (planar lightwave circuit) section 20, a connection section 30A on a light combining side, and a connection section 30B on a light splitting side, including a single substrate 10 made of Si (silicon) or the like.

In the embodiments, an example of the PLC section 20 includes, but is not limited to, a splitter having one light combining section and four light splitting sections. A splitter having arbitrary numbers of inputs and outputs may be used. Another PLC such as an optical switch may also be used.

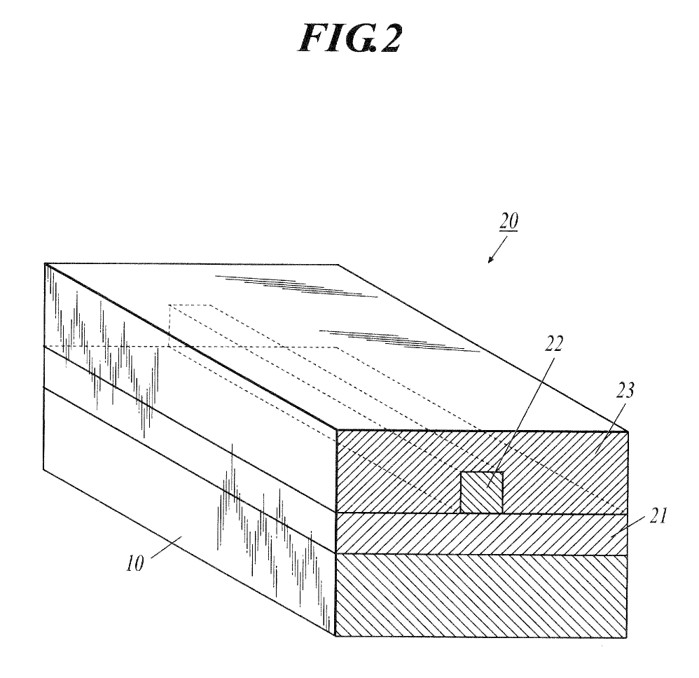

FIG. 2 shows a perspective configuration of a part of the PLC section 20. For brevity, FIG. 2 shows a longitudinal section of a part of the PLC section 20. As shown in FIG. 2, the PLC section 20 includes the substrate 10, a lower cladding layer 21, a core layer 22, and an upper cladding layer 23. The lower cladding layer 21 is made of fluorinated polyimide or the like and formed on the substrate 10. The core layer 22 as an optical waveguide is made of fluorinated polyimide or the like and formed on the lower cladding layer 21 into an optical waveguide pattern. The upper cladding layer 23 is made of the same material as that of the lower cladding layer and formed on the lower cladding layer 21 and the core layer 22.

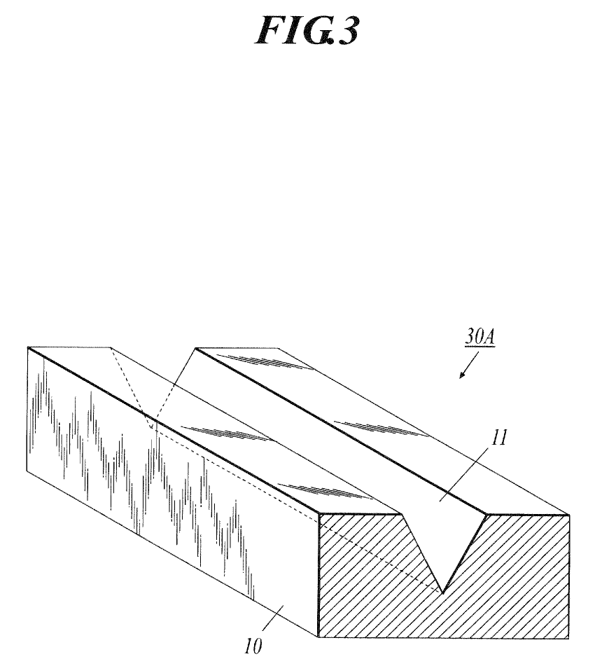

FIG. 3 shows a perspective configuration of a part of the connection section 30A. As shown in FIG. 1, in the connection section 30A, an end face of the optical fiber 41 for combining light is connected to an end face of the core layer 22 of the PLC section 20 on a light combining side so that light can be transmitted. As shown in FIG. 3, a V-groove 11 is formed on the substrate 10 of the connection section 30A. In the connection section 30A, the optical fiber 41 is fixed to the V-groove 11 and a cover 31A made of glass or the like is attached with an adhesive such as a UV (Ultra Violet) cure adhesive (resin).

In the connection section 30B, the optical fibers 42 to 45 for splitting light are connected to the core layer 22 of the PLC section 20 on a light splitting-side so that light can be transmitted. As with the connection section 30B, four V-grooves 11 are formed on the substrate 10 of the connection section 30B. In the connection section 30B, the optical fibers 42 to 45 are fixed to the V-grooves 11, respectively, and a cover 31B made of glass or the like is attached with an adhesive such as resin. Further, in addition to the V-groove 11 as a groove on the substrate 10, grooves such as V-shaped grooves may be provided on boundaries between the PLC section 20 and the connection sections 30A and 30B, respectively.

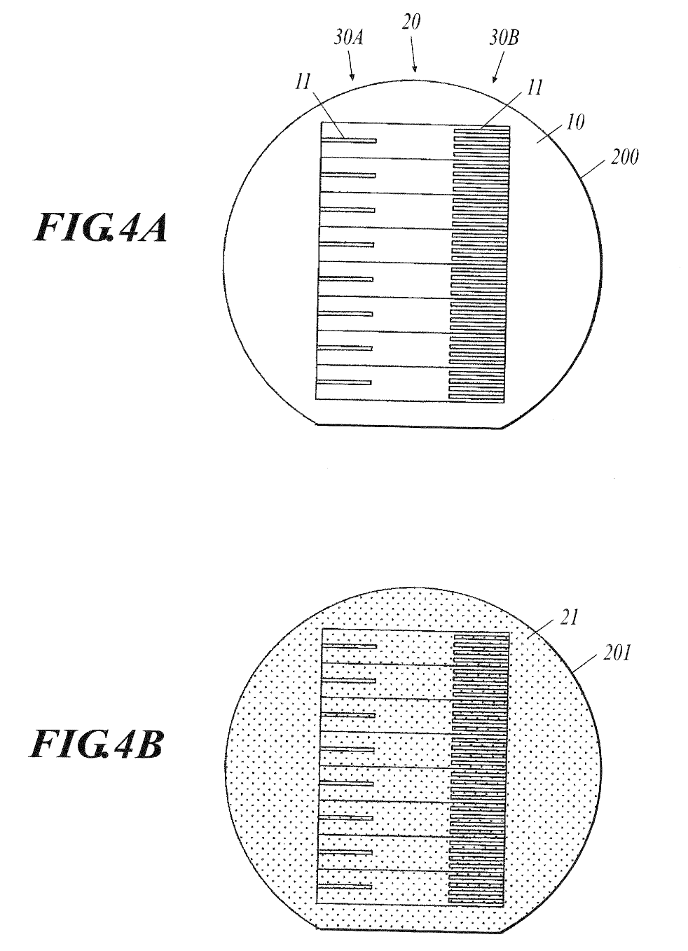

Next, referring to FIGS. 4 to 12, a method of manufacturing the optical waveguide module 1 will be described. While a method of manufacturing the connection section 30A characteristic of the embodiments will be described particularly in detail, much the same is true on a method of manufacturing the connection section 30B.

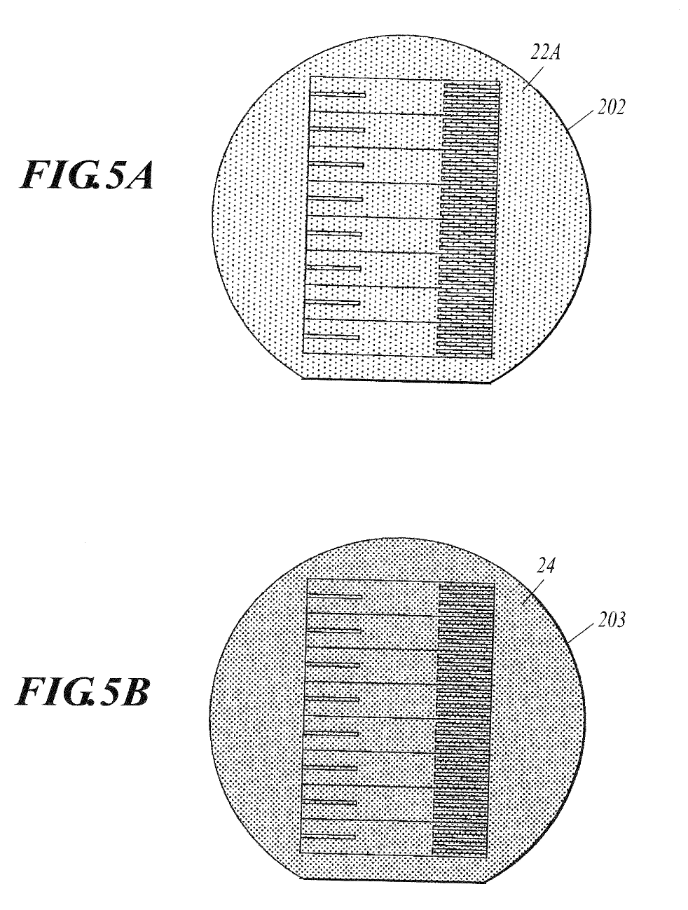

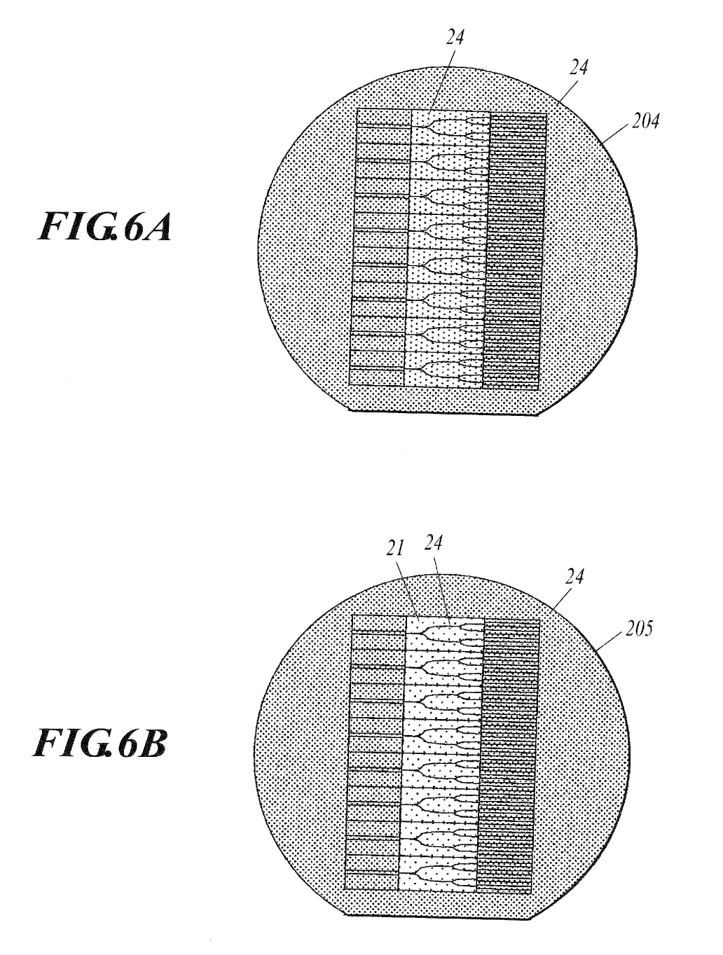

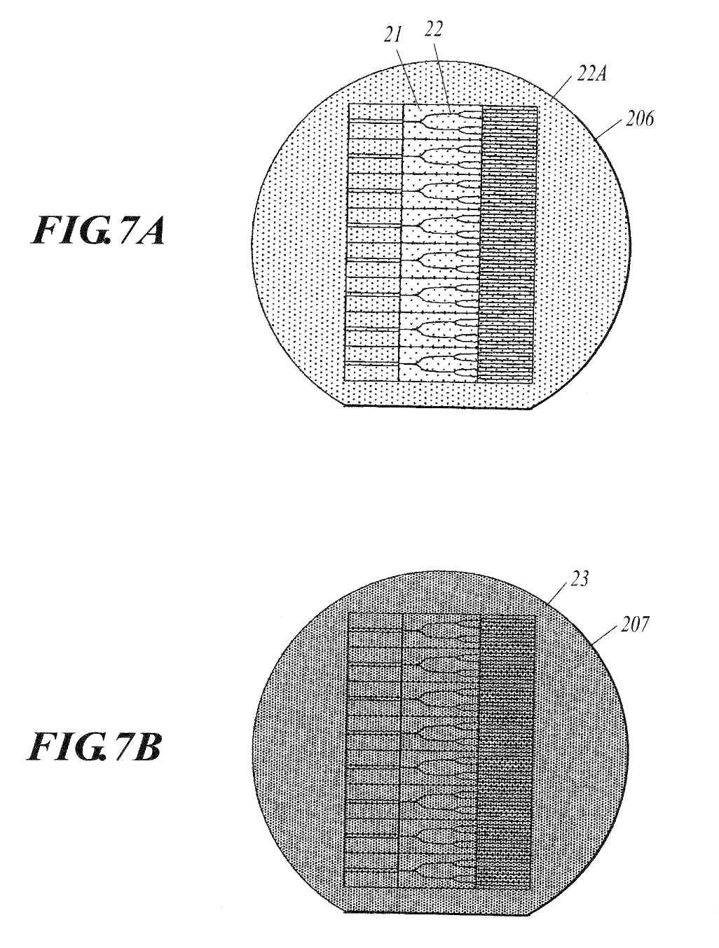

FIG. 4A shows a plane configuration of a wafer 200 in a V-groove forming step. FIG. 4B shows a plane configuration of a wafer 201 in a lower cladding layer forming step. FIG. 5A shows a plane configuration of a wafer 202 in a core layer forming step. FIG. 5B shows a plane configuration of a wafer 203 in a photoresist layer forming step. FIG. 6A shows a plane configuration of a wafer 204 in a photolithographic step. FIG. 6B shows a plane configuration of a wafer 205 in a core layer removing step. FIG. 7A shows a plane configuration of a wafer 206 in a photoresist layer removing step. FIG. 7B shows a plane configuration of a wafer 207 in an upper cladding layer step. FIG. 8 shows a plane configuration of the optical waveguide chip 100 in a chipping step. External lines of the respective chips shown in FIGS. 4A to 7 are added to indicate boundaries of the chips and not actual lines.

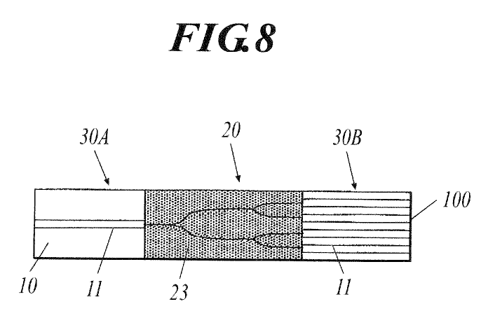

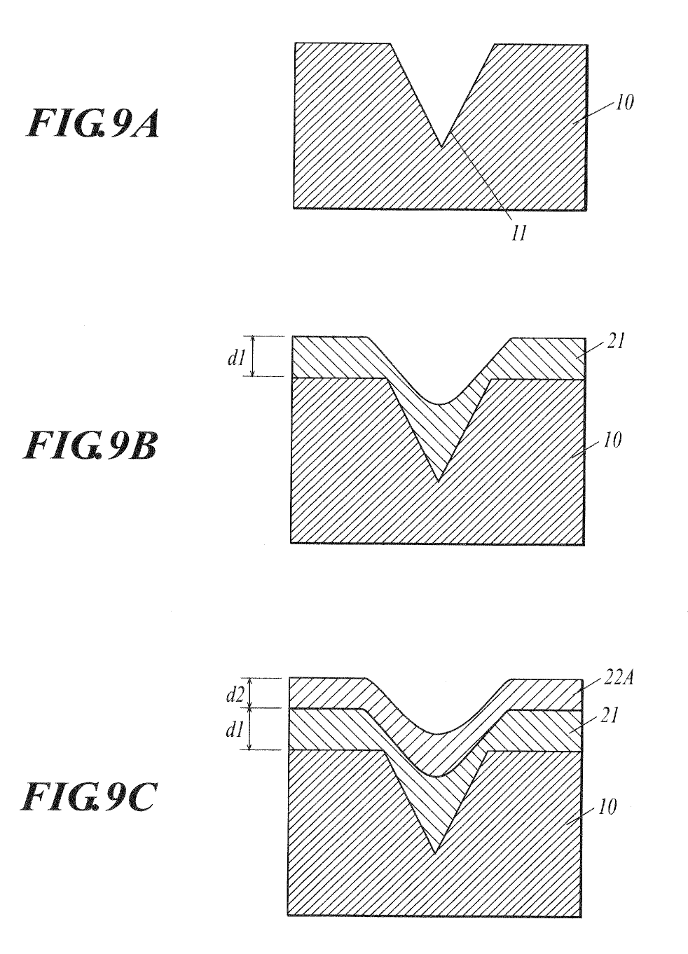

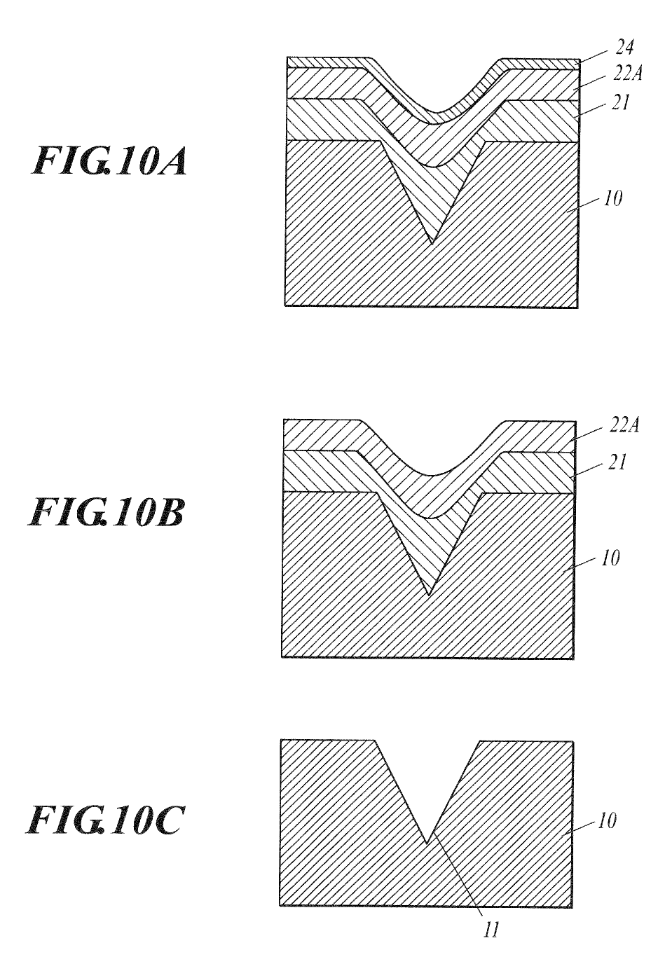

FIG. 9A shows a longitudinal section of the wafer in the V-groove forming step. FIG. 93 shows a longitudinal section of the wafer in the lower cladding layer forming step. FIG. 9C shows a longitudinal section of the wafer in the core layer forming step. FIG. 10A shows a longitudinal section of the wafer in the photoresist layer forming step. FIG. 10B shows a longitudinal section of the wafer in the photoresist layer removing step. FIG. 10C shows a longitudinal section of the wafer in the chipping step.

First, a wafer of the substrate 10 is formed out of silicon or the like. As shown in FIG. 4A, V-grooves 11 in the connection sections 30A and 30B are formed by anisotropic etching such as wet etching in the V-groove forming step, thereby changing the wafer into the wafer 200. Furthermore, although not shown, grooves are formed on the boundaries between the PLC section 20 and the connection sections 30A and 30B by wet etching or the like. As shown in FIG. 9A, for example, the substrate 10 having the V-groove 11 is formed in the connection section 30A.

As shown in FIG. 4B, a material of the lower cladding layer 21 is spin-coated on the substrate 10 and cured by heat treatment in the PLC section 20 and the connection sections 30A and 30B as the lower cladding layer forming step, thereby forming the lower cladding layer 21 and changing the wafer 200 to the wafer 201. As shown in FIG. 9B, for example, the lower cladding layer 21 is formed on the substrate 10 including the V-groove 11 in the connection section 30A. It is assumed that thickness (film thickness) of the lower cladding layer 21 is d1.

As shown in FIG. 5A, a material of a core layer 22A (a material of the core layer 22) is spin-coated on the substrate 10 and cured by heat treatment in the PLC section 20 and the connection sections 30A and 30B as the core layer forming step, thereby forming the core layer 22A and changing the wafer 201 to the wafer 202. As shown in FIG. 9C, for example, the core layer 22A is formed on the lower cladding layer 21 in the connection section 30A. It is assumed that thickness (film thickness) of the core layer 22A (the core layer 22) is d2.

FIG. 11 shows a relationship between a spinning speed and film thickness during spin coating. It is assumed that measuring conditions in relation to FIG. 11 are that 1.5 [ml] of a material is dropped to a spinner of 3 [inch] and the spinner is driven to rotate so as to attain 0→50 [rpm] in about 60 [s]. As shown in FIG. 11, the film thickness of the lower cladding layer 21 and the film thickness of the core layer 22A can be adjusted by changing the spinning speed [rpm]. In the embodiments, film thickness (d1+d2) of the lower cladding layer 21 and the core layer 22A is adjusted using the spinning speed so that the film thickness is larger than that of the conventional optical waveguide chip of the integrated type. Since the film thickness (d1+d2) is large, the lower cladding layer 21 and the core layer 22A are not made inappropriately thin at edges of the V-groove 11.

As shown in FIG. 5B, a material of the photoresist layer 24 is spin-coated on the substrate 10 in the PLC section 20 and the connection sections 30A and 30B as the photoresist layer forming step, thereby forming the photoresist layer 24 and changing the wafer 202 to the wafer 203. The material of the photoresist layer 24 is silicon-based resist or the like. As shown in FIG. 10A, for example, the photoresist layer 24 is formed on the core layer 22A in the connection section 30A.

As shown in FIG. 6A, a negative part or a positive part of an optical waveguide pattern is subjected to mask exposure in the PLC section 20 as the photolithographic step (core layer forming step), thereby forming the optical waveguide pattern and changing the wafer 203 to the wafer 204.

As shown in FIG. 6B, the core layer 22A (and the photoresist layer 24) that do not have the optical waveguide pattern are removed by dry etching such as reactive ion etching (RIE) in the PLC section 20 as the core layer removing step (core layer forming step), thereby forming the core layer 22 and the photoresist layer 24 that have the optical waveguide pattern and changing the wafer 204 to the wafer 205. The core layer 22A and the photoresist layer 24 in the connection sections 30A and 30B are left as they are.

As shown in FIG. 7A, the photoresist layer 24 having the optical waveguide pattern is removed by wet etching in the PLC section 20 and the connection sections 30A and 30B as the photoresist layer removing step, thereby changing the wafer 205 to the wafer 206. As shown in FIG. 10B, for example, the photoresist layer 24 is removed and the lower cladding layer 21 and the core layer 22A are left in the connection section 30A.

Since the film thickness (d1+d2) is large, there are no parts to which the resist material is not applied when forming the photoresist layer 24. Even at the time of dry etching on the core layer 22A (and the photoresist layer 24), no cracks occur to the lower cladding layer 21 near the edges of the V-grooves 11, and the wet etching solution used when the core layer 22 is removed does not enter between the lower cladding layer 21 and the substrate 10.

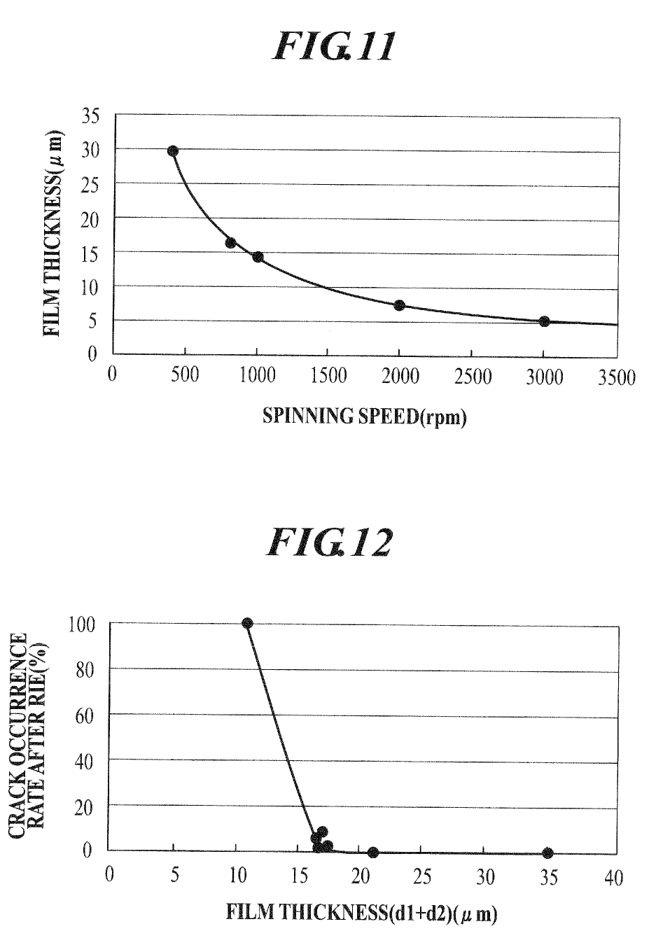

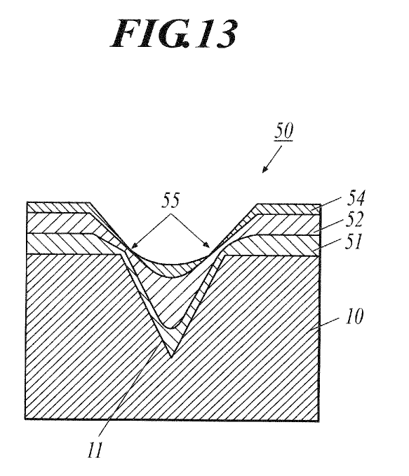

FIG. 12 shows a relationship between film thickness (d1+d2) and a crack occurrence rate after the etching (RIE) for removing the core layer 22A. As shown in FIG. 12, no cracks occur under the condition of 18 [μm]≦film thickness (d1+d2)≦35 [μm]. As shown in graph of FIG. 11, if film thickness (d1+d2)≧35 [μm], a rotational speed of the spin coating is quite low, e.g., about 500 [rpm] or lower. Therefore, it is not preferable that nonuniformity in film thickness distribution increases. Hence, in the embodiments, the condition is set as 18 [μm]≦film thickness (d1+d2)≦35 [μm].

Moreover, since optimum film thickness d2 of the core layer 22 is decided by a refraction difference between the lower cladding layer 21 and the core layer 22, it is preferable that the film thickness d1 of the lower cladding layer 21 can easily be changed.

As shown in FIG. 7B, a material of the upper cladding layer 23 is spin-coated on the substrate 10 and cured by heat treatment in the PLC section 20 and the connection sections 30A and 30B as the upper cladding layer forming step, thereby forming the upper cladding layer 23 and changing the wafer 206 to the wafer 207.

As shown in FIG. 8, the wafer 207 is cut off and separated into individual optical waveguide chips by dicing or the like in the chipping step. At this time, the upper cladding layer 23, the core layer 22 and the lower cladding layer 21 are removed from the V-grooves 11 in the connection sections 30A and 30B, thereby providing optical waveguide chips 100. The respective layers on the connection sections 30A and 30B can easily be detached when the wafer 207 is cut off. This is because no adhesive layer is present between the lower cladding layer 21 and the substrate 10 in the connection sections 30A and 30B.

In the chipping step, as shown in FIG. 10C, for example, the upper cladding layer 23 and the lower cladding layer 21 are removed and the substrate having the V-grooves 11 is left in the connection section 30A. Since the film thickness (d1+d2) is set large in the embodiments, no cracks occur to the lower cladding layer 21 and the lower cladding layer 21 can be removed highly accurately without occurrence of a residue.

In each of the optical waveguide chips 100, the optical fibers 41 to 45 for inputting or outputting light are attached and bonded to the V-grooves 11 with adhesive, and the covers 31A and 31B are attached, thereby providing the optical waveguide module 1.

As described above, according to the embodiments, in the manufacturing of the optical waveguide module 1, the lower cladding layer 21 and the core layer 22A are formed so that the film thickness (d1+d2) of the lower cladding layer 21 and the core layer 22A is set to be equal to or larger than 18 [μm]. It is therefore possible to prevent occurrence of a residue in the V-grooves 11 on the substrate 10, to prevent displacement of the optical fibers to be fixed to the V-grooves 11 and to reduce connection loss.

Moreover, the lower cladding layer 21 and the core layer 22A are formed so that the film thickness (d1+d2) of the lower cladding layer 21 and the core layer 22A is set to be equal to or smaller than 35 [μm]. It is therefore possible to reduce nonuniformity in film thickness distribution of the lower cladding layer 21 and the core layer 22A.

Furthermore, because the lower cladding layer 21 and the core layer 22A are formed by spin coating, it is possible to easily adjust the thicknesses of the lower cladding layer 21 and the core layer 22A.

The description of the embodiments is given as an example of the optical waveguide device and the method of manufacturing the optical waveguide device according to the present invention. The present invention is not limited to the embodiments.

For example, in the embodiments, the cladding layer, the core layer, and the photoresist layer are formed by spin coating. A formation method is not limited to the spin coating but these layers may be coated by spray coating or the like.

Furthermore, a detailed configuration and a detailed operation of the optical waveguide module 1 according to the embodiments may be appropriately changed without departing from the scope of the invention.

### INDUSTRIAL APPLICABILITY

As described above, an optical waveguide device and a method of manufacturing an optical waveguide device of the present invention are suitable for a device used in an optical communication and a method of manufacturing the same.

1. An optical waveguide device, comprising:
a substrate having a groove for fixing an optical fiber;
a lower cladding layer formed on the substrate;
a core layer having an optical waveguide pattern formed on the lower cladding layer; and
an upper cladding layer formed on the lower cladding layer and the core layer having the optical waveguide pattern, wherein a sum of thickness of the lower cladding layer and thickness of the core layer is 18 μm or more.

2. The optical waveguide device according to claim 1, wherein the sum of the thickness of the lower cladding layer and the thickness of the core layer is 35 μm or lower.

3. A method of manufacturing an optical waveguide device, comprising:
a step of forming a groove for fixing an optical fiber, on a substrate;
a lower cladding layer step of forming a lower cladding layer on the substrate;
a core layer step of forming a core layer on the lower cladding layer;
a step of forming a photoresist layer on the core layer;
a step of removing the core layer and the photoresist layer that do not have an optical waveguide pattern, and of removing a remaining photoresist layer;
a step of forming an upper cladding layer on the lower cladding layer and the core layer having the optical waveguide pattern; and
a step of removing the lower cladding layer, the core layer, and the upper cladding layer on the groove to manufacture the optical waveguide device,
wherein in the lower cladding layer step and the core layer step, a sum of thickness of the lower cladding layer and thickness of the core layer is set to be 18 μm or more.

4. The method of manufacturing an optical waveguide device according to claim 3, wherein in the lower cladding layer step and the core layer step, the sum of the thickness of the lower cladding layer and the thickness of the core layer is set to be 35 μm or lower.

5. The method of manufacturing an optical waveguide device according to claim 3, wherein in the lower cladding layer step and the core layer step, the lower cladding layer and the core layer are formed by spin coating or spray coating.
